(19) United States
(12) Patent Application Publication
(10) Pub. No.: US 2009/0300700 A1
(43) Pub. Date: Dec. 3, 2009

(54) REPLAYABLE TV SYSTEM

(75) Inventors: CHUNG-CHIH YEH, Tu-Cheng (TW); I-CHIH CHEN, Tu-Cheng (TW); DENG-RUNG LIU, Tu-Cheng (TW); CHIAO-YING WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/198,029

(22) Filed: Aug. 25, 2008

(30) Foreign Application Priority Data
Jun. 2, 2008 (CN) 200810301929.2

(51) Int. Cl. H04N 7/173

(52) U.S. Cl. 725/116

(57) ABSTRACT

A replayable TV system (100) comprises a multicast server (10), access to an IP TV network (20), a media server (30), at least one set top box (40), and a time-shift server (50). The multicast server multicasts a TV program to the media server and the at least one set top box through the IP TV network. The time-shift server controls the media server to record the program. At any time point during the multicasting of a TV program, if a set top box requests the time-shift server replay the TV program, the time-shift server sends the uniform resource locator corresponding to the TV program to the set top box. The set top box switches automatically from multicast unicast mode and receives the recorded program from the media server.

### BACKGROUND OF THE INVENTION

1. Field of the Invention

The present invention generally relates to replayable TV systems, and more particularly to a replayable TV system for network TV system.

2. Description of Related Art

With the development of Internet technology, the Internet is now widely used for transmitting information. With appearance of IP TV system, people can watch TV programs over the Internet. In a traditional IP TV network, a multicast server uses IP TV network as a transmitting medium. According to IGMP (Internet group management protocol), the multicast server sends AV (audio-video) files on multicast to the other devices in the network, such as at least one STB (set top box) for receiving TV program. Each of the at least one STB sends the AV files to a TV set, and then people can watch TV programs using the TV set.

However, currently people can only watch a TV program in process of playing. If a TV program has been already played and missed by people, people can not watch it. For example, if a scheduled playing time of a TV program is from 8:00 p.m. to 9:00 p.m., and if a person begins watching at 8:30 p.m., only the portion of the TV program played from 8:30 p.m. to 9:00 p.m. can be watched; the portion of the TV program played from 8:00 p.m. to 8:30 p.m. would be missed.

Therefore, there is room for improvement within the art.

### BRIEF DESCRIPTION OF THE DRAWINGS

Many aspects of the replayable TV system can be better understood with reference to the drawing. The drawing is not necessarily drawn to scale, the emphasis instead being placed upon clearly illustrating the principles of the present replayable TV system.

The drawing is a block diagram of a replayable TV system according to an exemplary embodiment of the invention.

### DETAILED DESCRIPTION OF THE EMBODIMENTS

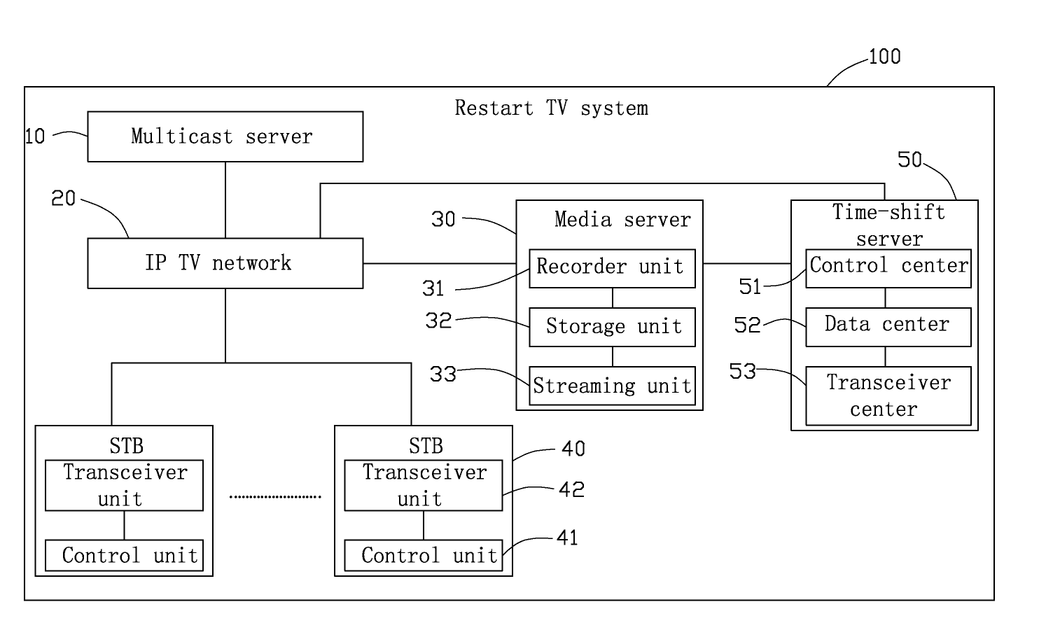

Referring to FIG. 1, an exemplary embodiment of a replayable TV system 100 is shown. The replayable TV system 100 includes a multicast server 10, access to an IP TV network 20 (used as an information transmitting medium), a media server 30, at least one STB 40, and a time-shift server 50. The multicast server 10, the media server 30, the at least one STB 40 and the time-shift server 50 are all electronically connected to the IP TV network 20 and can communicate with each other through the IP TV network 20.

The multicast server 10 multicasts an AV (audio-video) file of a TV program to the media server 30, the at least one STB 40, and any other devices in the network. The media server 30 includes a recorder unit 31, a storage unit 32 and a streaming unit 33. The recorder unit 31 receives the AV file being played by the multicast server 10, through the IP TV network 20. The recorder unit 31 records the AV file and stores it in the storage unit 32. Each AV file of the TV program has a corresponding URL (uniform resource locator). The AV file in the storage unit 32 can be sent by the streaming unit 33 in streaming format to at least one STB 40, and people can watch the TV program corresponding to the AV file in unicast form.

Each of the at least one STB 40 is a digital device with an embedded control system. The STB 40 is used for receiving and processing signal from IP TV network 20, such as audio, video, and control signals. The STB 40 includes a control unit 41 and a transceiver unit 42. The control unit 41 is configured for switching a receiving mode of the STB 40 between unicast or multicast modes. The control unit 41 includes a remote controller (not shown) and the receiving mode can be selected by pressing a key of the remote controller, such as a replay, stop or a channel switch key (none shown). The transceiver unit 42 is used for sending signal to time-shift server 50, or receiving signal from IP TV network 20, media server 30 and time-shift server 50. The STB 40 is usually connected to a television set or a display device so that a program received by the STB 40 can be displayed by the television set or the display device.

The time-shift server 50 includes a control center 51, a data center 52 and a transceiver center 53. The control center 51 is configured for controlling the operation of the media server 30, such as recording TV programs and document management. The data center 52 is configured for registering and arranging information of a TV program, such as the URL of a TV program. The transceiver center 53 is configured for receiving information form the STB 40 and the media server 30, and sending information to the STB 40 and the media server 30.

When used, take the time for televising a TV program as a time scale, for example, if a scheduled televising time of a TV program is from 8:00 p.m. to 9:00 p.m., then the time from 8:00 p.m. to 9:00 p.m. is a time scale. When the TV program is being televised, the multicast server 10 transmits the AV file of the TV program to the media server 30 and the at least one STB 40 through the IP TV network 20, so that people can watch the TV program from the STB 40. At the beginning of the TV program, the time-shift server 50 automatically controls the recorder unit 31 of the media server 30 to record the multicast TV program and store the program in the storage unit 32. The time-shift server 50 confirms whether the media server 30 is recording the TV program. If yes, the time-shift server 50 obtains the URL of the TV program from the media server 30, and stores the URL into the data center 52. If not, the time-shift server 50 controls the recorder unit 31 to record the TV program.

At any time point during the time scale of 8:00 p.m. to 9:00 p.m., if someone wants to replay the TV program being played during the time scale, the control unit 41 should be processed. For example, the replay key of the remote controller is pressed, so that the control unit 41 sends a control signal for replaying the program to the transceiver unit 53 of the time-shift server 50, and sends a request to the time-shift server 50 for replaying the program. The transceiver unit 53 sends the URL corresponding to the TV program to the transceiver unit 42 of STB 40. The control unit 41 of the STB 40 switches automatically from multicast to unicast mode, disconnects from the multicast server 10 and connects to the media server 30. The STB 40 requests to the media server 30 for the TV program scheduled incurrent time scale. The media server 30 sends the TV program to the STB 40 in audio and video streaming, and the people can watch the program from the beginning.

When a person wants to stop the unicast program, and continue watching a live TV broadcast, the control unit 41 should again be processed. For example, the stop or channel switch key of the remote controller is pressed, and the control unit 41 of the STB 40 switches automatically from unicast to multicast mode, and reconnect to the multicast server 10. Then, Live TV programs in the process of broadcasting by the IP TV network 20 can be watched. For example, a person may watch the unicast program from 8:30 p.m. to 8:45 p.m., switch from unicast to multicast mode at 8:45 p.m., and then, watch the live TV program scheduled in 8:45 p.m. The unicast program can be requested at any time point during the multicast from 8:00 p.m. to 9:00 p.m., and an unlimited number of times. However, if the replay key is pressed after 9:00 p.m., only the program scheduled for play during the time scale after 9:00 p.m. can be watched.

It should be understood that, the media server 30 can be connected to a plurality of STBs 40, and can meet replay request of many STBs 40 in the same time. In addition, the media server 30 and the time-shift server 40 can be integrated into a single unit as a program replay server. Furthermore, the replayable TV system 100 can be suitable for different IP TV networks 20.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A replayable TV system comprising:
access to an IP TV network, at least one set top box, a multicast server, a media server, and a time-shift server;
the multicast server multicasting a TV program to the media server and the at least one set top box through the IP TV network;
the time-shift server controlling the media server to record the multicast TV program;
wherein if at any time during the multicasting of a TV program, a set top box request the time-shift server replay the TV program, the time-shift server sends the uniform resource locator corresponding to the recorded TV program to the set top box, and the set top box switches automatically from multicast to unicast mode and receives the recorded TV program from the media server.

2. The replayable TV system of claim 1, wherein the media server includes a recorder unit receiving and recording the program being multicast by the multicast server through IP TV network, a storage unit storing the recorded program, and a streaming unit for meeting requests of a plurality of set top boxes and sending the program stored in the storage unit to the requesting set top boxes.

3. The replayable TV system of claim 2, wherein the time-shift server comprises a control center for controlling the media server, a data center for registering and arranging uniform TV program information, and a transceiver center for receiving/sending information from/to the set top box and media server.

4. The replayable TV system of claim 3, wherein the time-shift server confirms that if the media server is recording the TV program, the time-shift server obtains the uniform resource locator of the TV program from the media server, and stores the uniform resource locator in the data center.

5. The replayable TV system of claim 1, wherein each set top box comprises a control unit for switching a receiving mode between unicast or multicast modes, and a transceiver unit for sending signals to the time-shift server or receiving signals from the IP TV network, media server and time-shift server.

6. The replayable TV system of claim 1, wherein the media server and the time-shift server are integrated into a single unit.
